(19) United States
(12) Patent Application Publication
(10) Pub. No.: US 2013/0208121 A1
(43) Pub. Date: Aug. 15, 2013

(54) TRAFFIC CAMERA DIAGNOSTICS VIA TEST TARGETS

(71) Applicants: Wencheng Wu, Webster, NY (US); Martin E. Hoover, Rochester, NY (US)

(72) Inventors: Wencheng Wu, Webster, NY (US); Martin E. Hoover, Rochester, NY (US)

(73) Assignee: Xerox Corporation

(21) Appl. No.: 13/371,068

(22) Filed: Feb. 10, 2012

(51) Int. Cl. H04N 17/00; H04N 7/18

(52) U.S. Cl. 348/149; 348/E07.085; 348/E17.002

(57) ABSTRACT

A method, system, and computer-usable tangible storage device for traffic camera diagnostics via strategic use of moving test targets are disclosed. The disclosed embodiments can comprise four modules: Moving test target management module, Moving test target detection and identification module, Image/video feature extraction module, and Sensor characterization and diagnostics module. A first test vehicle can travel periodically through traffic camera(s) of interest. The traffic camera(s) would then identify these test vehicles via matching of license plate numbers and then identify test targets in video frames through pattern matching or barcode reading. The identified test targets are then analyzed to extract image and video features that can be used for sensor characterization, sensor health assessment, and sensor diagnostics. The disclosed embodiments provide for a non-traffic-stop (i.e., non-traffic-interruption) traffic camera diagnostics.

### TECHNICAL FIELD

The disclosed embodiments relate to data-processing systems and methods. The disclosed embodiments further relate to camera diagnostics. The disclosed embodiments also relate to strategic use of moving test targets for traffic camera diagnostics.

### BACKGROUND OF THE INVENTION

Numerous localities use traffic cameras for video surveillance, security applications, and transportation applications. Traffic cameras are also used for traffic monitoring, traffic management, and for fee collection and/or photo enforcement for open road tolling, red light, speed enforcement etc. For example, in an effort to curb red-light running and promote better driving, some localities have implemented automated traffic enforcement systems, such as red light monitoring and enforcement systems. Red light monitoring and enforcement systems can be predictive in nature. The system can predict if a vehicle is going to run a red light by determining how fast a vehicle approaches an intersection and capturing images of the vehicle running the red light.

Maintenance of vast quantities of traffic cameras is a challenging undertaking. These cameras are often not easily accessible, usually being mounted on a pole high up in the air to prevent vandalism or better field of view. It is also difficult to set-up and perform camera diagnostics with the power and wiring for the cameras often located in the ground while the cameras are high up in the air. Further, there is often no display to view and analyze the immediately-acquired data during the maintenance or diagnostics. It is also difficult to place test targets in the field of view (i.e. “FOV”) in the center of traffic without disturbing or disrupting traffic.

Prior proposed solutions fail to address the traffic camera diagnostics problem. One can use indirect information (e.g. the yield of ALPR system or the frequency of the need of manual plate reading can be an indirect indication of camera quality degradation), or use elements in the scene (e.g. use static sharp edges found in the scene to test/track the focus of the camera) to do some level of diagnostics. But the capability and accuracy of these options are very limited and often scene and application dependent.

Therefore, a need exists for controlled and specialized test targets placed in the FOV for traffic camera diagnostics. It is thus the objective of this invention to propose a cost-effective and accurate system to overcome the limitations of prior proposed solutions. Key advantages of this invention include cost saving (e.g. no need for lane/traffic stops, less manual intervention) and better diagnostics performance (e.g. use of controlled/specialized test targets in the FOV, more points than static test targets, less scene dependency etc.).

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for improved data-processing systems and methods.

It is another aspect of the disclosed embodiments to provide for improved camera diagnostics.

It is a further aspect of the disclosed embodiments to provide for strategic use of moving test targets for traffic camera diagnostics.

The above and other aspects can be achieved as is now described. A method, system, and computer-usable tangible storage device for traffic camera diagnostics via strategic use of moving test targets are disclosed. The disclosed embodiments can comprise four modules: Moving test target management module, Moving test target detection and identification module, Image/video feature extraction module, and Sensor characterization and diagnostics module. A first test vehicle can travel periodically through traffic camera(s) of interest. The traffic camera(s) would then identify these test vehicles via matching of license plate numbers and then identify test targets in video frames through pattern matching or barcode reading. The identified test targets are then analyzed to extract image and video features that can be used for sensor characterization, sensor health assessment, and sensor diagnostics. The disclosed embodiments provide for a non-traffic-stop (i.e., non-traffic-interruption) traffic camera diagnostics.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exemplary block diagram of a sample data-processing apparatus, which can be utilized for processing secure data, in accordance with the disclosed embodiments;

FIG. 2 illustrates an exemplary schematic view of a software system including an operating system, application software, and a user interface, in accordance with the disclosed embodiments;

FIG. 3 illustrates an exemplary block diagram of a system for traffic camera diagnostics via strategic use of moving test targets, in accordance with the disclosed embodiments;

FIG. 4 illustrates an exemplary pictorial illustration of a test vehicle with test target, grid of 180° reflectors, mounted on a folding trailer hitch, in accordance with the disclosed embodiments;

FIG. 5 illustrates an exemplary block diagram of example data analysis algorithm for deriving camera to real-world coordinate mapping T_{c}, in accordance with the disclosed embodiments;

FIG. 6 illustrates an exemplary enhanced pictorial illustration 600 of a field of view (FOV) of a road segment captured by a Dalsa 4M60 camera, in accordance with the disclosed embodiments;

FIG. 7 illustrates an exemplary graphical illustration of the corners of a FOV and a selected reference point in the image coordinate, in accordance with the disclosed embodiments;

FIG. 8 illustrates an exemplary graphical illustration of an estimated FOV in real-world using the camera to real-world coordinate mapping T_{c} derived from analyzing moving grid targets, in accordance with the disclosed embodiments;

FIG. 9 illustrates an exemplary pictorial illustration of an enhanced image from diagnosing FOV changes over time, in accordance with the disclosed embodiments;

FIG. 10 illustrates an exemplary pictorial illustration of an enhanced image from diagnosing FOV changes over time, in accordance with the disclosed embodiments; and

FIG. 11 illustrates an exemplary graphical illustration of a FOV map for FOV changes over time, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, one or more of the disclosed embodiments can be embodied as a method, system, or computer program usable medium or computer program product. Accordingly, the disclosed embodiments can in some instances take the form of an entirely hardware embodiment, an entirely software embodiment or an embodiment combining software and hardware aspects all generally referred to herein as a “module”. Furthermore, the disclosed embodiments may take the form of a computer usable medium, computer program product, a computer-readable tangible storage device storing computer program code, said computer program code comprising program instructions executable by said processor on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.) The computer program code, however, for carrying out operations of the present invention may also be written in conventional procedural programming languages, such as the “C” programming language or in a programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The disclosed embodiments are described in part below with reference to flowchart illustrations and/or block diagrams of methods, systems, computer program products and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

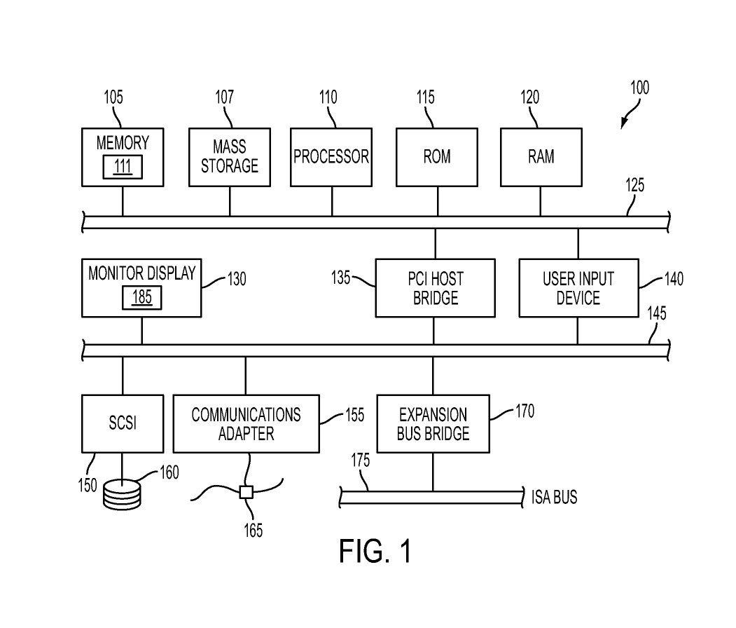

FIG. 1 illustrates a block diagram of a sample data-processing apparatus 100, which can be utilized for an improved traffic camera diagnostics method and system. Data-processing apparatus 100 represents one of many possible data-processing and/or computing devices, which can be utilized in accordance with the disclosed embodiments. It can be appreciated that data-processing apparatus 100 and its components are presented for generally illustrative purposes only and do not constitute limiting features of the disclosed embodiments.

As depicted in FIG. 1, a memory 105, a mass storage 107 (e.g., hard disk), a processor (CPU) 110, a Read-Only Memory (ROM) 115, and a Random-Access Memory (RAM) 120 are generally connected to a system bus 125 of data-processing apparatus 100. Memory 105 can be implemented as a ROM, RAM, a combination thereof, or simply a general memory unit. Module 111 includes software module in the form of routines and/or subroutines for carrying out features of the present invention and can be additionally stored within memory 105 and then retrieved and processed via processor 110 to perform a particular task. A user input device 140, such as a keyboard, mouse, or another pointing device, can be connected to PCI (Peripheral Component Interconnect) bus 145. Note that the term “GUI” generally refers to a type of environment that represents programs, files, options and so forth by means of graphically displayed icons, menus, and dialog boxes on a computer monitor screen.

Data-process apparatus 100 can thus include CPU 110, ROM 115, and RAM 120, which are also coupled to a PCI (Peripheral Component Interconnect) local bus 145 of data-processing apparatus 100 through PCI Host Bridge 135. The PCI Host Bridge 135 can provide a low latency path through which processor 110 may directly access PCI devices mapped anywhere within bus memory and/or input/output (I/O) address spaces. PCI Host Bridge 135 can also provide a high bandwidth path for allowing PCI devices to directly access RAM 120.

A communications adapter 155, a small computer system interface (SCSI) 150. An expansion bus-bridge 170 can also be attached to PCI local bus 145. The communications adapter 155 can be utilized for connecting data-processing apparatus 100 to a network 165. SCSI 150 can be utilized to control high-speed SCSI disk drive 160. An expansion bus-bridge 170, such as a PCI-to-ISA bus bridge, may be utilized for coupling ISA bus 175 to PCI local bus 145. Note that PCI local bus 145 can further be connected to a monitor 130, which functions as a display (e.g., a video monitor) for displaying data and information for a user and also for interactively displaying a graphical user interface (GUI) 185. A user actuates the appropriate keys on the GUI 185 to select data file options.

The embodiments described herein can be implemented in the context of a host operating system and one or more modules. Such modules may constitute hardware modules, such as, for example, electronic components of a computer system. Such modules may also constitute software modules. In the computer programming arts, a software “module” can be typically implemented as a collection of routines and data structures that performs particular tasks or implements a particular abstract data type.

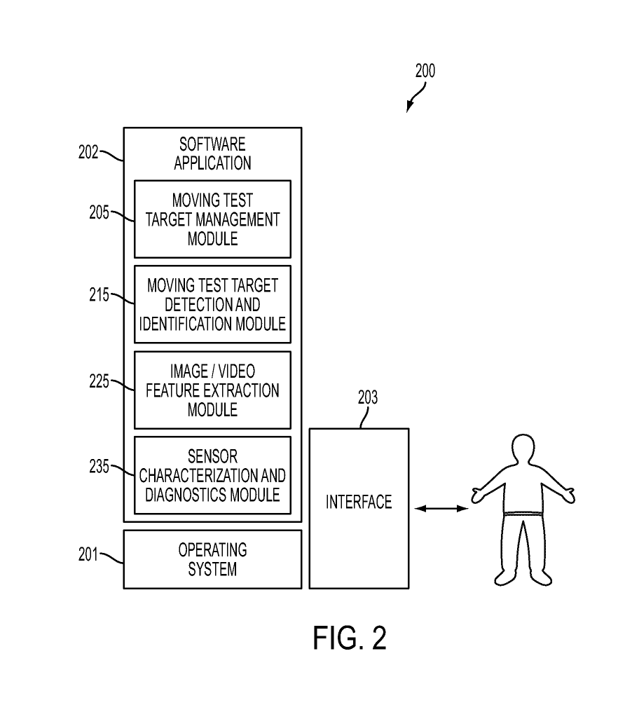

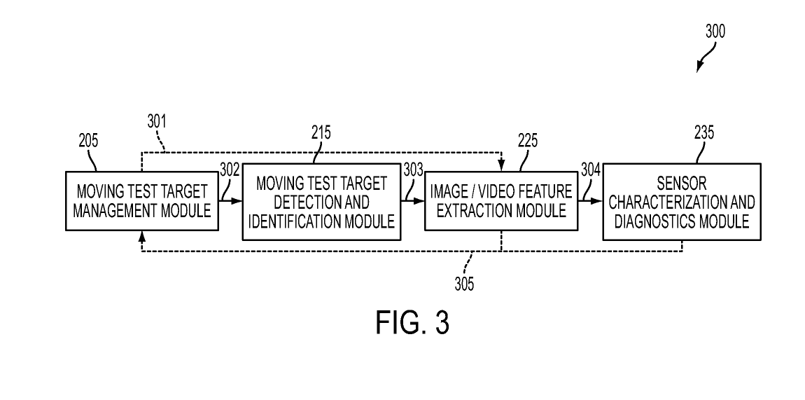

Software modules generally can include instruction media storable within a memory location of an image processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term “module” as utilized herein can therefore generally refer to software modules or implementations thereof. Such modules can be utilized separately or together to form a program product that can be implemented through signal-bearing media, including transmission media and/or recordable media. Examples of such modules that can embody features of the present invention are a moving test target management module 205, a moving test target detection and identification module 215, an image/video feature extraction module 225, and a sensor characterization and diagnostics module 235, as depicted in FIG. 2 and further described in FIG. 3.

It is important to note that, although the embodiments are described in the context of a fully functional data-processing system (e.g., a computer system), those skilled in the art will appreciate that the mechanisms of the embodiments are capable of being distributed as a program product in a variety of forms, and that the present invention applies equally regardless of the particular type of signal-bearing media utilized to actually carry out the distribution. Examples of signal bearing media include, but are not limited to, recordable-type media such as media storage or CD-ROMs and transmission-type media such as analogue or digital communications links.

FIG. 2 illustrates a schematic view of a software system 200 including an operating system, application software, and a user interface for carrying out the disclosed embodiments. Computer software system 200 directs the operation of the data-processing system 100 depicted in FIG. 1. Software application 202, stored in main memory 105 and on mass storage 107, includes a kernel or operating system 201 and a shell or interface 203. One or more application programs, such as software application 202, may be “loaded” (i.e., transferred from mass storage 107 into the main memory 105) for execution by the data-processing system 100. The data-processing system 100 receives user commands and data through the interface 203, as shown in FIG. 2. The user's command input may then be acted upon by the data-processing system 100 in accordance with instructions from operating module 201 and/or application module 202.

The interface 203 also serves to display traffic camera diagnostics, whereupon the user may supply additional inputs or terminate the session. In an embodiment, operating system 201 and interface 203 can be implemented in the context of a “Windows” system. It can be appreciated, of course, that other types of systems are potential. For example, rather than a traditional “Windows” system, other operation systems, such as, for example, Linux may also be employed with respect to operating system 201 and interface 203. The software application 202 can include a moving test target management module 205, a moving test target detection and identification module 215, an image/video feature extraction module 225, and a sensor characterization and diagnostics module 235. The software application 202 can also be configured to communicate with the interface 203 and various components and other modules and features as described herein.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program design to assist in the performance of a specific task, such as word processing, accounting, inventory management, music program scheduling, etc.

Generally, program modules include routines, programs, objects, components, data structures, etc., that perform particular tasks or implement particular abstract data types. Moreover, those skilled in the art will appreciate that the disclosed method and system may be practiced with other computer system configurations, such as, for example, hand-held devices, multi-processor systems, microprocessor-based or programmable consumer electronics, networked PCs, minicomputers, mainframe computers, and the like.

FIG. 3 illustrates an exemplary block diagram 300 of a system for traffic camera diagnostics via strategic use of moving test targets, in accordance with the disclosed embodiments. The disclosed embodiments improve traffic camera diagnostics via strategic use of moving test targets. It comprises the following four modules: (1) Moving test target management module 205; (2) Moving test target detection and identification module 215; (3) Image/video feature extraction module 225; and (4) Sensor characterization and diagnostics module 235. As implemented, for example, a first test vehicle can travel periodically past traffic camera(s) of interest. The traffic camera(s) would then identify these test vehicles via matching of license plate numbers and then identify test targets in video frames through pattern matching or barcode reading. The identified test targets are then analyzed to extract image and video features that can be used for sensor characterization, sensor health assessment, and sensor diagnostics. The disclosed embodiments provide for a non-traffic-stop (i.e., non-traffic-interruption) traffic camera diagnostics.

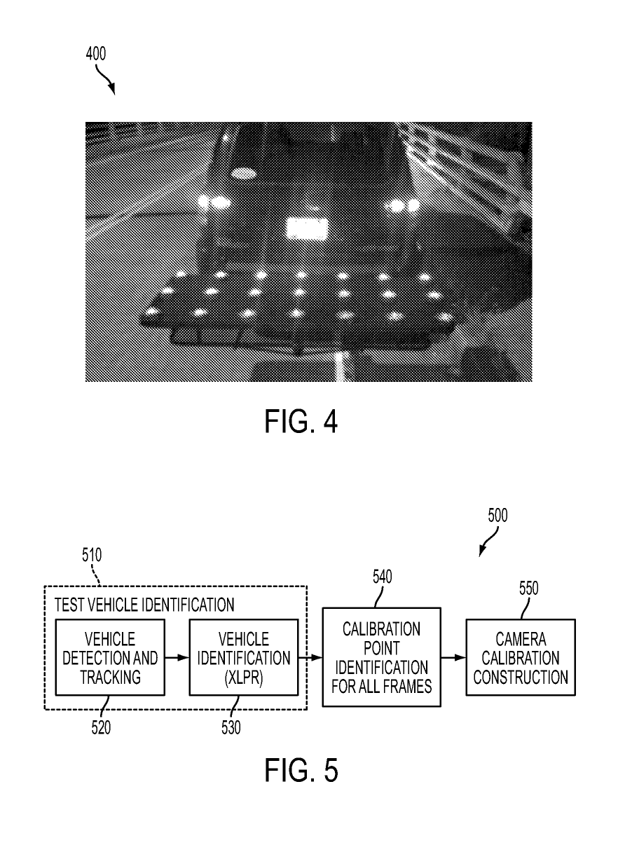

The Moving test target management module 205 ensures that relevant moving test targets will appear in the FOV of traffic cameras of interest for some amount of occurrences. Optionally, it can also provide 301, 302 the schedule and other information about test targets, test vehicles, etc. to other modules. Interaction between this module and others 215, 225, 235 is highly dependent on the capability of other modules 215, 225, 235. At minimum, moving test target management module 205 needs to determine where to send test targets and which test vehicles to carry the test targets. It can be completely random or based on the trip schedule of service representatives or based on the feedback from specific traffic camera(s). The test targets can be painted on the test vehicles, put on a trailer and dragged by test vehicles, or mounted on top of the test vehicles, etc. FIG. 4 illustrates an exemplary pictorial illustration 400 of a test vehicle with test target, grid of 180° reflectors, mounted on a folding trailer hitch, in accordance with the disclosed embodiments. Note also that the term “moving” test target can imply that the test vehicle can park in the middle of the traffic or move very slowly in traffic if the traffic situation is as such.

Continuing with FIG. 3, the Moving test target detection and identification module 215 detects the presence of test targets and identifies distinguishing features of a specific test target, such as, for example, a line pattern with eleven 3-inch lines spacing 9-inches apart or a circular dots with 3-inch diameter. Line patterns can be used, for example, for measuring scanner or camera modulation transfer function (i.e., “MTF”). The Moving test target detection and identification module 215 communicates 303 with the image/video feature extraction module 225 for the image/video feature extraction module 225 to properly extract image/video features. The image/video features can be used to characterize, monitor, assess, and/or diagnose a particular sensed traffic camera. There are many ways to characterize, monitor, assess, and/or diagnose a particular sensed traffic camera, such as, for example:

Through the identification of test vehicles that carry the test targets, one can recognize the presence of test targets in video frames using pattern matching or barcode reading. In this case, moving test target management module 205 needs to communicate 302 the test vehicle's collected information (e.g. license plate numbers) to the moving test target detection and identification module 215. Automated License Plate Recognition (“ALPR”) technology can be used to locate a test vehicle. A barcode can be used to identify the specific type of the moving test targets.

Through direct detection and identification of the test targets (similarly using pattern matching, barcode reading etc.), one can characterize, monitor, assess, and/or diagnose a sensed traffic camera. In this case, the moving test target management module 205 does not need to communicate 302 the test vehicle's collected information.

Through a direct communication between test vehicles and the traffic cameras, one can characterize, monitor, assess, and/or diagnose a sensed traffic camera. For example, the test vehicle can send a direct signal to each traffic camera (preferably a smart camera) when it enters its FOV.

The Image/video feature extraction module 225 extracts image and/or video features from the sensed moving test targets. The image and/or video features can be communicated 304 to the sensor characterization and diagnostics module 235 to characterize, monitor, assess, and/or diagnose the traffic cameras. The Image/video feature extraction module 225 analyzes test targets. The analysis is test-target dependent and application dependent. Analysis can include, for example, use of line patterns for MTF, sensor focus, and sensor color-plane registration, use of checkerboard for understanding change of geometry distortion for an indication of camera FOV moved, etc.

Sensor characterization and diagnostic module 235 can use the above mentioned extracted image/video features for sensor characterization, health monitoring and diagnostics. The analyses done by this module is test-target dependent and application dependent. For example, the Sensor characterization and diagnostic module 235 can track the resulting MTF or image blur over time to diagnose and/or prognose sensor degradation in focus or change of focus. For another example, the Sensor characterization and diagnostic module 235 can track the amount of changes in the geometry distortion over time to discover any FOV changes of the sensor, etc.

Though in the above discussion a feed forward communication is described from moving test target management module 205 to other modules 215, 225, 235, it is possible to have a feedback communication. In a feedback communication system, the traffic camera sensor(s) request a specific set of test targets for diagnostics based on its current diagnostic results (such as 305 in FIG. 3). Note that the term “diagnostic” means both diagnostic (i.e., detect issues that already happened) and prognostic (i.e., predict when an issue will happen).

The moving test target management module 205 also gathers and communicates 301, 302 additional information, such as test vehicle's travelling schedule (e.g., route and time), speed, where the test targets are mounted etc. to the other modules 215, 225, 235. For example, the schedule information can help moving test target detection and identification module 215 to narrow down the search range of videos if ALPR system fails. For another example, knowing the test vehicle travelling speed can help sensor characterization and diagnostic module 235 to parse out the contribution of sensor optical blur versus object motion blur for the observed test target blur. Although one can derive vehicle speed from reference marks on the moving test target directly, having the additional information available upfront can simplify or speed-up the analysis or can be used as verification information.

Motion correction to compensate for the distortion from test vehicle travelling speed in FOV can be performed before the sensor characterization and diagnostic module 235. For example, one can use existing motion correction technique in video processing prior to the extraction of image/video features in the image/video feature extraction module 225. For another example, one can simply build a speed compensation look-up table by collecting data from moving test targets at different test vehicle speeds.

FIG. 5 illustrates an exemplary block diagram 500 of example data analysis algorithm for deriving camera to real-world coordinate mapping T_{c}, in accordance with the disclosed embodiments. For test vehicle identification 510, vehicle detection and tracking is first implemented 520 for vehicle identification 530. To monitor the change of field of view (FOV), the collected positions of the moving grid targets are used to perform camera calibration identification for all frames 540, i.e. the transformation T_{c} of pixel position (i,j) to real-world coordinates (x,y) at grid plane height z=z₀. T_{c} is denoted here as T_{c}:(i,j)→(x,y,z₀). Camera calibration construction then follows 550. For the purpose of diagnosing change of FOV, FOV is further inferred based on the derived T_{c} by:

First arbitrarily specifying (but keeping it the same once chosen) a reference point where T_{c}(i₀,j₀)=(0,0,z₀). The FOV is estimated by feeding the four corners in the image plane, (1,1), (1,N), (M,N), (M,1) into the current camera calibration map T_{c}. If this task is performed many times over a period of time for each or selected camera out in the field, the estimated FOV is collected and logged each time to monitor the change of FOV for each identified camera.

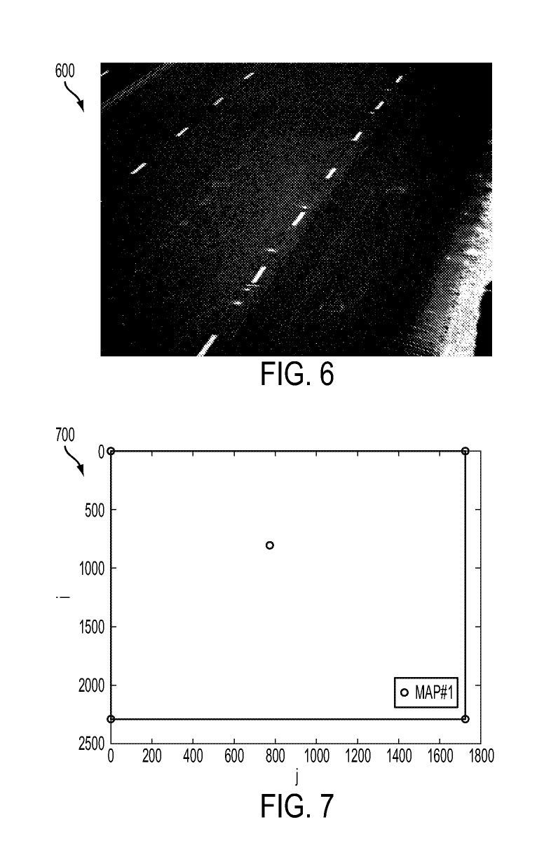

FIG. 6 illustrates an exemplary enhanced pictorial illustration 600 of a field of view (FOV) of a road segment captured by a Dalsa 4M60 camera, in accordance with the disclosed embodiments.

FIG. 7 illustrates an exemplary graphical illustration 700 an estimated FOV in real-world using the camera to real-world coordinate mapping T_{c} derived from analyzing moving grid targets, in accordance with the disclosed embodiments. To test the ability of monitoring the change in the FOV based on a method described in this invention, a camera was mounted on a pole for three days; and the camera was re-focus daily based on a focus procedure, thus slightly changing the FOV.

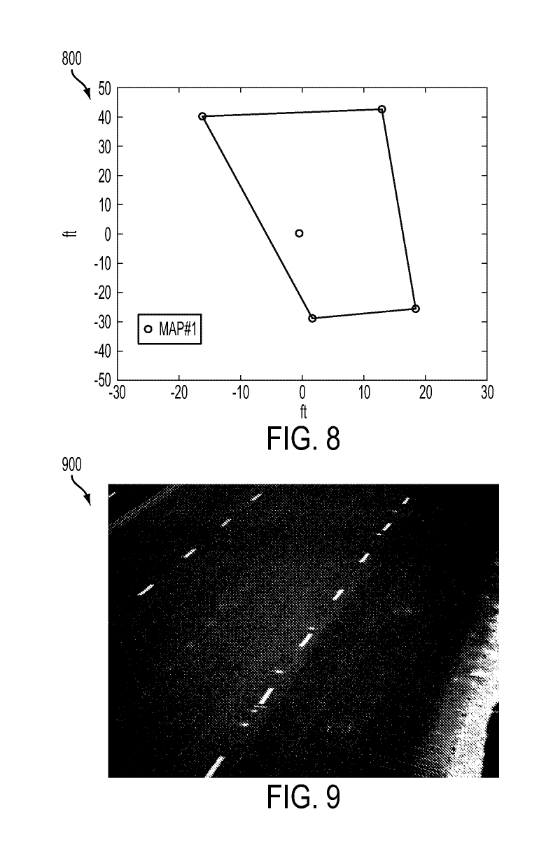

FIG. 8 illustrates an exemplary graphical illustration 800 of the corners of a FOV and a selected reference point in the image coordinate, in accordance with the disclosed embodiments. Notice that in the third day, the FOV is increased for about 6% in area (˜3% in y-direction where vehicles travel). This translates to about 3% bias in speed detection accuracy if without compensation. Indeed, this expected amount was verified independently from the test, where a reference Lidar-based speed detector was used to compare against our video-based speed detection algorithm. Change in FOV is an exemplary diagnostic routine as implemented in the disclosed embodiments. It is noted that other characteristics can be diagnosed, such as, for example, optical blur with a proper design of “test patterns” that would go with the test vehicle and a corresponding image/video analysis.

For example, a periodic line pattern or a set of sharp texts can be painted on a board and mounted on a hitch, just like that shown in FIG. 4 but replacing the grid target board with this one. This line pattern or text pattern can then be used for diagnosing and monitoring the optical blur/out of focus of a traffic camera using our proposed system.

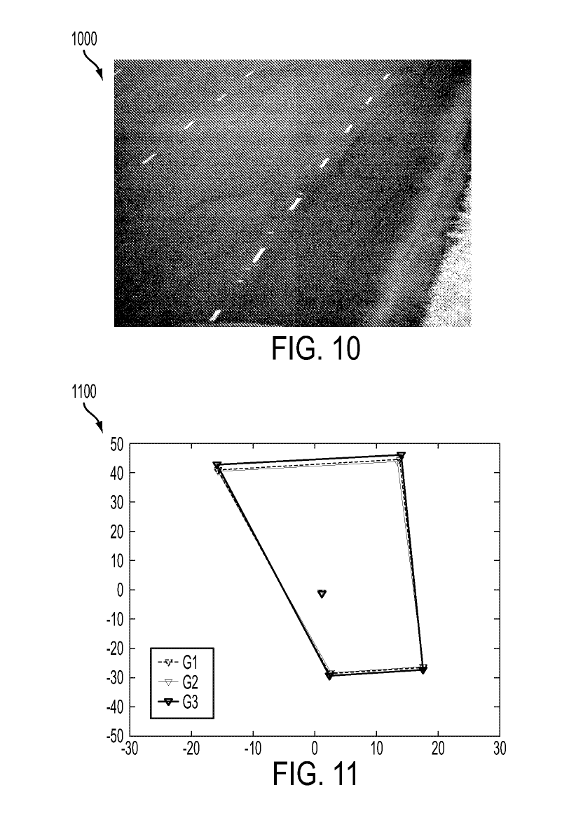

FIG. 9 illustrates an exemplary pictorial illustration of an enhanced image from diagnosing FOV changes over time, specifically day 2 (G2), in accordance with the disclosed embodiments. FIG. 10 illustrates an exemplary pictorial illustration of an enhanced image from diagnosing FOV changes over time, in accordance with the disclosed embodiments, specifically day 3 (G3). FIG. 11 illustrates an exemplary graphical illustration of FOV maps for FOV changes over time from all three days, in accordance with the disclosed embodiments. From FIGS. 9 and 10, it is clear that it is difficult to assess the amount of change in FOVs between day 2 and 3 by human inspection alone. On the other hand, as shown in FIG. 11, with the use of moving grid target and corresponding analysis, it is easy to accurately assess the amount of change in FOVs between these two days.

Based on the foregoing, it can be appreciated that a number of different embodiments, preferred and alternative are disclosed herein. For example, in one embodiment, a method for traffic camera diagnostics via strategic use of at least one moving test target associated with at least one test vehicle is disclosed. The method can include steps for: positioning the at least one moving test target in a field of view of a traffic camera to diagnose the traffic camera; detecting a presence of the at least one moving test target by the traffic camera; extracting features of the at least one moving test target to analyze the extracted features of the at least one moving test target; and analyzing the extracted features of the at least one moving test target to characterize, monitor, assess, or diagnose the traffic camera.

In other embodiments, the method can include a step for identifying the at least one moving test target via at least one of pattern matching, barcode reading of a segment of an image of the at least one moving test target, layout of the at least one moving test target, and appearance of a sub-target element. In another embodiment, the method can include a step for identifying the test vehicle via automatic license plate recognition. In yet another embodiment, the method can include steps for: communicating information collected by the test vehicle for the at least one moving test target; communicating a traveling schedule of the test vehicle to narrow down a search range of the visual data if automatic license plate recognition of the test vehicle fails; and communicating a traveling speed of the test vehicle to parse out a contribution of sensor optical blur versus objection motion blur for an observed test target blur.

In other embodiments, analyzing the extracted visual features of the at least one moving test target further comprises using at least one of line patterns for measuring at least one of sensor modulation transfer function, sensor focus, sensor color-plane registration, use of checkerboard for understanding change of geometry distortion for an indication that the field of view for the traffic camera moved. While in other embodiments, analyzing the extracted visual features of the at least one moving test target further comprises tracking a resulting camera modulation transfer function or image blur over time to track the amount of changes in the geometry distortion over time to diagnose or prognose sensor degradation of the traffic camera.

In another embodiment, the method can include a step for compensating for distortion from a traveling speed of the test vehicle wherein the test vehicle is located in the field of view of the traffic camera. The method can further include a step for requesting another test target for additional diagnostics based on current diagnostic results. In another embodiment, steps are provided for monitoring a change of the field of view by collecting and logging an estimated field of view and performing traffic camera calibration identification for all collected positions of field of view frames.

In certain embodiments, diagnosis of the traffic camera comprises at least one of change in field of view and optical blur with a line test pattern design. In other embodiments, the at least one moving test target comprises at least one of a fixed test target, a test target selected from a pre-determined collection of a plurality of test targets, a test target created from a collection of a plurality of test target sub-elements. In another embodiment, the at least one moving test target is selected based at least one of a result of a previous traffic diagnostic trip, pre-knowledge about a specific site of a traffic camera of interest, and a specific goal a particular trip wherein the goal comprises at least one of camera blur and diagnosing a change in field of view of the traffic camera of interest.

In another embodiment, a system for traffic camera diagnostics via strategic use of at least one moving test target associated with at least one test vehicle is disclosed. The system can include a processor, a data bus coupled to the processor, and a computer-usable storage medium storing computer code, the computer-usable storage medium being coupled to the data bus. The computer program code can include program instructions executable by the processor and configured to position the at least one moving test target in a field of view of a traffic camera to diagnose the traffic camera; detect a presence of the at least one moving test target by the traffic camera; extract features of the at least one moving test target to analyze the extracted features of the at least one moving test target; and analyze the extracted features of the at least one moving test target to characterize, monitor, assess, or diagnose the traffic camera.

In other embodiments, the system can include program instructions to: identify the at least one moving test target via at least one of pattern matching, barcode reading of a segment of an image of the at least one moving test target, layout of the at least one moving test target, and appearance of a sub-target element; identify the test vehicle via automatic license plate recognition; compensate for distortion from a traveling speed of the test vehicle wherein the test vehicle is located in the field of view of the traffic camera; monitor a change of the field of view by collecting and logging an estimated field of view; perform traffic camera calibration identification for all collected positions of field of view frames; diagnose the traffic camera comprises via at least one of change in field of view and optical blur with a line test pattern design; and request another test target for additional diagnostics based on current diagnostic results.

In another embodiment the system can include program instruction to: communicate information collected by the test vehicle for the at least one moving test target; communicate a traveling schedule of the test vehicle to narrow down a search range of the visual data if automatic license plate recognition of the test vehicle fails; and communicate a traveling speed of the test vehicle to parse out a contribution of sensor optical blur versus objection motion blur for an observed test target blur.

In embodiments including analyzing the extracted visual features of the at least one moving test target, additional program instructions can be provided to use at least one of line patterns for measuring at least one of sensor modulation transfer function, sensor focus, sensor color-plane registration, use of checkerboard for understanding change of geometry distortion for an indication that the field of view for the traffic camera moved; and track a resulting camera modulation transfer function or image blur over time to track the amount of changes in the geometry distortion over time to diagnose or prognose sensor degradation of the traffic camera.

In other embodiments, the at least one moving test target comprises at least one of a fixed test target, a test target selected from a pre-determined collection of a plurality of test targets, a test target created from a collection of a plurality of test target sub-elements. In yet another embodiment, the at least one moving test target is selected based at least one of on a result of a previous traffic diagnostic trip, pre-knowledge about a specific site of a traffic camera of interest, and a specific goal a particular trip wherein the goal comprises at least one of camera blur and diagnosing a change in field of view of the traffic camera of interest.

In another embodiment, a computer-usable tangible storage device storing computer program code, the computer program code comprising program instructions executable by a processor for traffic camera diagnostics via strategic use of at least one moving test target associated with at least one test vehicle is disclosed. The computer program code can include program instructions executable by a processor to: position the at least one moving test target in a field of view of a traffic camera to diagnose the traffic camera; detect a presence of the at least one moving test target by the traffic camera; extract features of the at least one moving test target to analyze the extracted features of the at least one moving test target; and analyze the extracted features of the at least one moving test target to characterize, monitor, assess, or diagnose the traffic camera.

In some embodiments, the computer-usable tangible storage device can have program instructions to: identify the at least one moving test target via at least one of pattern matching, barcode reading of a segment of an image of the at least one moving test target, layout of the at least one moving test target, and appearance of a sub-target element; identify the test vehicle via automatic license plate recognition; compensate for distortion from a traveling speed of the test vehicle wherein the test vehicle is located in the field of view of the traffic camera; monitor a change of the field of view by collecting and logging an estimated field of view; perform traffic camera calibration identification for all collected positions of field of view frames; diagnose the traffic camera comprises via at least one of change in field of view and optical blur with a line test pattern design; request another test target for additional diagnostics based on current diagnostic results; communicate information collected by the test vehicle for the at least one moving test target; communicate a traveling schedule of the test vehicle to narrow down a search range of the visual data if automatic license plate recognition of the test vehicle fails; communicate a traveling speed of the test vehicle to parse out a contribution of sensor optical blur versus objection motion blur for an observed test target blur; use at least one of line patterns for measuring at least one of sensor modulation transfer function, sensor focus, sensor color-plane registration, use of checkerboard for understanding change of geometry distortion for an indication that the field of view for the traffic camera moved; and track a resulting camera modulation transfer function or image blur over time to track the amount of changes in the geometry distortion over time to diagnose or prognose sensor degradation of the traffic camera.

In yet other embodiments, the at least one moving test target can comprise at least one of a fixed test target, a test target selected from a pre-determined collection of a plurality of test targets, a test target created from a collection of a plurality of test target sub-elements. In another embodiment, the at least one moving test target is selected based at least one of on a result of a previous traffic diagnostic trip, pre-knowledge about a specific site of a traffic camera of interest, and a specific goal a particular trip wherein the goal comprises at least one of camera blur and diagnosing a change in field of view of the traffic camera of interest.

It will be appreciated that variations of the above-disclosed and other features and functions, or alternatives thereof, may be desirably combined into many other different systems or applications. Furthermore, various presently unforeseen or unanticipated alternatives, modifications, variations or improvements therein may be subsequently made by those skilled in the art which are also intended to be encompassed by the following claims.

What is claimed is:

1. A method for traffic camera diagnostics via strategic use of at least one moving test target associated with at least one test vehicle, comprising:
positioning said at least one moving test target in a field of view of a traffic camera to diagnose said traffic camera;
detecting a presence of said at least one moving test target by said traffic camera;
extracting features of said at least one moving test target to analyze said extracted features of said at least one moving test target; and
analyzing said extracted features of said at least one moving test target to characterize, monitor, assess, or diagnose said traffic camera.

2. The method of claim 1 further comprising identifying said at least one moving test target via at least one of pattern matching, barcode reading of a segment of an image of said at least one moving test target, layout of said at least one moving test target, and appearance of a sub-target element.

3. The method of claim 1 further comprising identifying said test vehicle via automatic license plate recognition.

4. The method of claim 1 further comprising:
communicating information collected by said test vehicle for said at least one moving test target;
communicating a traveling schedule of said test vehicle to narrow down a search range of said visual data if automatic license plate recognition of said test vehicle fails; and
communicating a traveling speed of said test vehicle to parse out a contribution of sensor optical blur versus objection motion blur for an observed test target blur.

5. The method of claim 1 wherein analyzing said extracted visual features of said at least one moving test target further comprises using at least one of line patterns for measuring at least one of sensor modulation transfer function, sensor focus, sensor color-plane registration, use of checkerboard for understanding change of geometry distortion for an indication that said field of view for said traffic camera moved.

6. The method of claim 1 wherein analyzing said extracted visual features of said at least one moving test target further comprises tracking a resulting camera modulation transfer function or image blur over time to track the amount of changes in the geometry distortion over time to diagnose or prognose sensor degradation of said traffic camera.

7. The method of claim 1 further comprising compensating for distortion from a traveling speed of said test vehicle wherein said test vehicle is located in said field of view of said traffic camera.

8. The method of claim 1 further comprising requesting another test target for additional diagnostics based on current diagnostic results.

9. The method of claim 1 further comprising:
monitoring a change of said field of view by collecting and logging an estimated field of view;
performing traffic camera calibration identification for all collected positions of field of view frames.

10. The method of claim 1 wherein said diagnosis of said traffic camera comprises at least one of change in field of view and optical blur with a line test pattern design.

11. The method of claim 1 wherein said at least one moving test target comprises at least one of a fixed test target, a test target selected from a pre-determined collection of a plurality of test targets, a test target created from a collection of a plurality of test target sub-elements.

12. The method of claim 1 wherein said at least one moving test target is selected based at least one of on a result of a previous traffic diagnostic trip, pre-knowledge about a specific site of a traffic camera of interest, and a specific goal a particular trip wherein said goal comprises at least one of camera blur and diagnosing a change in field of view of said traffic camera of interest.

13. A system for traffic camera diagnostics via strategic use of at least one moving test target associated with at least one test vehicle, comprising:
a processor;
a data bus coupled to said processor; and
a computer-usable tangible storage device storing computer program code, said computer program code comprising program instructions executable by said processor, said program instructions comprising:
program instructions to position said at least one moving test target in a field of view of a traffic camera to diagnose said traffic camera;
program instructions to detect a presence of said at least one moving test target by said traffic camera;
program instructions to extract features of said at least one moving test target to analyze said extracted features of said at least one moving test target; and
program instructions to analyze said extracted features of said at least one moving test target to characterize, monitor, assess, or diagnose said traffic camera.

14. The system of claim 13 further comprising:
program instructions to identify said at least one moving test target via at least one of pattern matching, barcode reading of a segment of an image of said at least one moving test target, layout of said at least one moving test target, and appearance of a sub-target element;
program instructions to identify said test vehicle via automatic license plate recognition;
program instructions to compensate for distortion from a traveling speed of said test vehicle wherein said test vehicle is located in said field of view of said traffic camera;
program instructions to monitor a change of said field of view by collecting and logging an estimated field of view;
program instructions to perform traffic camera calibration identification for all collected positions of field of view frames;
program instructions to diagnose said traffic camera comprises via at least one of change in field of view and optical blur with a line test pattern design; and
program instructions to request another test target for additional diagnostics based on current diagnostic results.

15. The system of claim 13 further comprising:
program instructions to communicate information collected by said test vehicle for said at least one moving test target;
program instructions to communicate a traveling schedule of said test vehicle to narrow down a search range of said visual data if automatic license plate recognition of said test vehicle fails; and
program instructions to communicate a traveling speed of said test vehicle to parse out a contribution of sensor optical blur versus objection motion blur for an observed test target blur.

16. The system of claim 13 wherein analyzing said extracted visual features of said at least one moving test target further comprises:
program instructions to use at least one of line patterns for measuring at least one of sensor modulation transfer function, sensor focus, sensor color-plane registration, use of checkerboard for understanding change of geometry distortion for an indication that said field of view for said traffic camera moved; and
program instructions to track a resulting camera modulation transfer function or image blur over time to track the amount of changes in the geometry distortion over time to diagnose or prognose sensor degradation of said traffic camera.

17. The system of claim 13 wherein:
said at least one moving test target comprises at least one of a fixed test target, a test target selected from a pre-determined collection of a plurality of test targets, a test target created from a collection of a plurality of test target sub-elements; and
said at least one moving test target is selected based at least one of on a result of a previous traffic diagnostic trip, pre-knowledge about a specific site of a traffic camera of interest, and a specific goal a particular trip wherein said goal comprises at least one of camera blur and diagnosing a change in field of view of said traffic camera of interest.

18. A computer-usable tangible storage device storing computer program code, said computer program code comprising program instructions executable by a processor for traffic camera diagnostics via strategic use of at least one moving test target associated with at least one test vehicle, said program instructions comprising:
program instructions to position said at least one moving test target in a field of view of a traffic camera to diagnose said traffic camera;
program instructions to detect a presence of said at least one moving test target by said traffic camera;
program instructions to extract features of said at least one moving test target to analyze said extracted features of said at least one moving test target; and
program instructions to analyze said extracted features of said at least one moving test target to characterize, monitor, assess, or diagnose said traffic camera.

19. The computer-usable tangible storage device of claim 18 further comprising:
program instructions to identify said at least one moving test target via at least one of pattern matching, barcode reading of a segment of an image of said at least one moving test target, layout of said at least one moving test target, and appearance of a sub-target element;
program instructions to identify said test vehicle via automatic license plate recognition;
program instructions to compensate for distortion from a traveling speed of said test vehicle wherein said test vehicle is located in said field of view of said traffic camera;
program instructions to monitor a change of said field of view by collecting and logging an estimated field of view;
program instructions to perform traffic camera calibration identification for all collected positions of field of view frames;
program instructions to diagnose said traffic camera comprises via at least one of change in field of view and optical blur with a line test pattern design; program instructions to request another test target for additional diagnostics based on current diagnostic results;
program instructions to communicate information collected by said test vehicle for said at least one moving test target;
program instructions to communicate a traveling schedule of said test vehicle to narrow down a search range of said visual data if automatic license plate recognition of said test vehicle fails;
program instructions to communicate a traveling speed of said test vehicle to parse out a contribution of sensor optical blur versus objection motion blur for an observed test target blur;
program instructions to use at least one of line patterns for measuring at least one of sensor modulation transfer function, sensor focus, sensor color-plane registration, use of checkerboard for understanding change of geometry distortion for an indication that said field of view for said traffic camera moved; and
program instructions to track a resulting camera modulation transfer function or image blur over time to track the amount of changes in the geometry distortion over time to diagnose or prognose sensor degradation of said traffic camera.

20. The computer-usable tangible storage device of claim 18 wherein:
said at least one moving test target comprises at least one of a fixed test target, a test target selected from a pre-determined collection of a plurality of test targets, a test target created from a collection of a plurality of test target sub-elements; and
said at least one moving test target is selected based at least one of a result of a previous traffic diagnostic trip, pre-knowledge about a specific site of a traffic camera of interest, and a specific goal a particular trip wherein said goal comprises at least one of camera blur and diagnosing a change in field of view of said traffic camera of interest.
